(19) United States
(12) Patent Application Publication
(10) Pub. No.: US 2026/0101365 A1
(43) Pub. Date: Apr. 9, 2026

(54) METHOD AND APPARATUS FOR QUALITY MANAGING OF EXTENDED REALITY SERVICE IN COMMUNICATION NETWORK

(71) Applicant: ELECTRONICS AND TELECOMMUNICATIONS RESEARCH INSTITUTE, Daejeon (KR)

(72) Inventors: Sung Cheol CHANG, Daejeon (KR); Jae Sun CHA, Daejeon (KR)

(73) Assignee: ELECTRONICS AND TELECOMMUNICATIONS RESEARCH INSTITUTE, Daejeon (KR)

(21) Appl. No.: 19/348,888

(22) Filed: Oct. 3, 2025

(30) Foreign Application Priority Data
Oct. 4, 2024 (KR) 10-2024-0135001
Nov. 8, 2024 (KR) 10-2024-0157773
Feb. 7, 2025 (KR) 10-2025-0016010
May 9, 2025 (KR) 10-2025-0060340
Aug. 14, 2025 (KR) 10-2025-0113398
Oct. 2, 2025 (KR) 10-2025-0145143

(51) Int. Cl. H04W 72/563; H04L 47/28; H04L 47/283

(52) U.S. Cl. CPC H04W 72/563; H04L 47/283; H04L 47/286

(57) ABSTRACT

A method of a terminal, for quality management of an extended reality service, may comprise: receiving, from a base station, information on a first priority, a second priority, and a remaining delay time reference for a logical channel; configuring a timer for each of a plurality of packets received from a higher layer; determining whether at least one delay-critical packet is present among the plurality of packets based on the remaining delay time reference; based on the at least one delay-critical packet not being present, applying the first priority to uplink resource allocation, and based on the at least one delay critical packet being present, applying the second priority to the uplink resource allocation; and transmitting the plurality of packets to the base station based on at least one of the first priority or the second priority.

### CROSS-REFERENCE TO RELATED APPLICATIONS

This application claims priority to Korean Patent Applications No. 10-2024-0135001, filed on Oct. 4, 2024, No. 10-2024-0157773, filed on Nov. 8, 2024, No. 10-2025-0016010, filed on Feb. 7, 2025, No. 10-2025-0060340, filed on May 9, 2025, No. 10-2025-0113398, filed on Aug. 14, 2025, and No. 10-2025-0145143, filed on Oct. 2, 2025, with the Korean Intellectual Property Office (KIPO), the entire contents of which are hereby incorporated by reference.

### BACKGROUND

### 1. Technical Field

The present disclosure relates to an extended reality (XR) technique in a communication network, and more particularly, to a method and apparatus for quality of service (QoS) management on an XR service having multi-modality characteristics.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, discussions have been actively conducted on communication technologies for providing extended reality (XR) services that have multi-modality characteristics in communication networks. Multi-modality may refer to a function that enables a user, when experiencing virtual reality (VR) or augmented reality (AR), to transmit and/or receive information through various sensory organs of the user, for example, vision, hearing, touch, or smell. Through such multi-modality, the user can obtain a more realistic and immersive experience.

Communication technologies for XR services need to consider both the individual requirement characteristics of experiences that the user can obtain and the integrated characteristics required from the user perspective. Accordingly, methods of managing quality of service (QoS) for inter-related characteristics required by XR experiences are required.

### SUMMARY

The present disclosure for resolving the above-described problems is directed to providing a method and apparatus for quality of service (QoS) management on an XR service.

A method of a terminal for quality management of an extended reality service, according to an exemplary embodiment of the present disclosure, may comprise: receiving, from a base station, information on a first priority, a second priority, and a remaining delay time reference for a logical channel; configuring a timer (discardTimer) for each of a plurality of packets received from a higher layer; determining whether at least one delay-critical packet is present among the plurality of packets based on the remaining delay time reference; based on the at least one delay-critical packet not being present, applying the first priority to uplink resource allocation, and based on the at least one delay critical packet being present, applying the second priority to the uplink resource allocation; and transmitting the plurality of packets to the base station based on at least one of the first priority or the second priority.

The determining of whether the at least one delay-critical packet is present may comprise: comparing a remaining delay time of a timer corresponding to each of the plurality of packets with the remaining delay time reference; and based on at least one remaining delay time among the plurality of timer remaining delay times being smaller than the remaining delay time reference, determining that the at least one delay-critical packet is present among the plurality of packets, and based on at least one remaining delay time among the plurality of timer remaining delay times not being smaller than the remaining delay time reference, determining that the at least one delay-critical packet is not present among the plurality of packets.

The determining of whether the at least one delay-critical packet is present may comprise: receiving, from the base station, information on a pdu-SetDiscard field for a protocol data unit (PDU) set; and based on a remaining delay time of at least one of packets having an identical PDU set sequence number (SN) being smaller than the remaining delay time reference, determining, according to the pdu-SetDiscard field, that the at least one delay-critical packet is present among the plurality of packets, and based on a remaining delay time of at least one of packets having an identical PDU set SN being not smaller than the remaining delay time reference, determining, according to the pdu-SetDiscard field, that the at least one delay-critical packet is not present among the plurality of packets.

The determining of whether the at least one delay-critical packet is present may comprise: receiving, from the base station, information on an mMPDU-SetDiscard field for a multi-modality (MM) PDU set; and based on a remaining delay time of at least one of packets having an identical multi-modality PDU set SN being smaller than the remaining delay time reference, determining, according to the mMPDU-SetDiscard field, that the at least one delay-critical packet is present among the plurality of packets, and based on a remaining delay time of at least one of packets having an identical multi-modality PDU set SN not being smaller than the remaining delay time reference, determining, according to the mMPDU-SetDiscard field, that the at least one delay-critical packet is not present among the plurality of packets.

The method may further comprise: receiving, from the base station, information on a prioritized bit rate (PBR) and a bucket size duration (BSD); determining a bucket (B) size based on at least one of the PBR or the BSD; based on the bucket size being greater than 0, allocating first-stage uplink resources to at least one packet among the plurality of packets of the logical channel, the at least one packet corresponding to a range of the bucket size; decreasing the bucket size based on a size of the allocated first-stage uplink resources; and allocating second-stage uplink resources to each of remaining packets of the logical channel.

The allocating of the first-stage uplink resources may comprises allocating the first-stage uplink resources by applying the second priority, and the allocating of the second-stage uplink resources may comprise: based on the at least one delay-critical packet being present among the remaining packets, allocating the second-stage uplink resources by applying the second priority; and based on the at least one delay-critical packet not being present among the remaining packets, allocating the second-stage uplink resources by applying the first priority.

The allocating of the first-stage uplink resources may comprises based on the PBR being configured as a specific value, allocating the first-stage uplink resources to each of the plurality of packets, and the allocating of the second-stage uplink resources may comprise: uniformly allocating the second-stage uplink resources to a same logical channel.

The method may further comprise: transmitting, to the base station, a delay status report (DSR) message including delay time information for each of the plurality of packets.

A method of a terminal for quality management of an extended reality service, according to another exemplary embodiment of the present disclosure, may comprise: receiving, from a base station, information on a report remaining time indicating a delay status report (DSR) time for each logical channel group and information on a plurality of remaining delay time ranges; based on a remaining delay time of a packet received from a higher layer being equal to or less than the report remaining time, triggering a DSR generation event; and transmitting a DSR medium access control (MAC) control element (MAC CE) to the base station using uplink resources allocated from the base station.

The DSR MAC CE may include a minimum remaining delay time field and a buffer size field corresponding to at least one section of the logical channel group, and the transmitting of the DSR MAC CE to the base station may comprise: setting, in the minimum remaining delay time field, a minimum remaining delay time of at least one packet corresponding to a remaining delay time range in at least one logical channel of the logical channel group; and setting, in the buffer size field, a sum of sizes of the at least one packet.

The at least one packet may include at least one packet in a packet data convergence protocol (PDCP) service data unit (SDU) format or a PDCP packet data unit (PDU) format.

The setting of the sum of sizes of the at least one packet in the buffer size field may comprise: receiving, from the base station, information on a dsr-ReportNonDelayCriticalData field; and based on the dsr-ReportNonDelayCriticalData field, setting, in the buffer size field, a sum of sizes of at least one packet corresponding to a packet that does not correspond to the remaining delay time range in at least one of the plurality of logical channels, wherein the at least one packet may include at least one packet in a PDCP SDU format or a PDCP PDU format.

The DSR MAC CE may include an E field indicating an extension of a reporting pair of a minimum remaining delay time field and a buffer size field for each logical channel group, and the transmitting of the DSR MAC CE to the base station may comprise: setting a value of the E field to 1 to add a reporting pair of a minimum remaining delay time field and a buffer size field in a logical channel group corresponding to the DSR; and setting the value of the E field to 0 to indicate a last reporting pair in the logical channel group.

The method may further comprise: based on the uplink resources not being allocated from the base station, transmitting, to the base station, a scheduling request for requesting uplink resource allocation.

The method may further comprise: based on at least one of packet information or a packet related to the DSR MAC CE being transmitted to the base station, cancelling the DSR generation event.

A terminal for quality management of an extended reality service, according to an exemplary embodiment of the present disclosure, may comprise: at least one processor. The at least one processor may cause the terminal to perform: receiving, from a base station, information on a first priority, a second priority, and a remaining delay time reference for a logical channel; configuring a timer (discardTimer) for each of a plurality of packets received from a higher layer; determining whether at least one delay-critical packet is present among the plurality of packets based on the remaining delay time reference; based on the at least one delay-critical packet not being present, applying the first priority to uplink resource allocation, and based on the at least one delay critical packet being present, applying the second priority to the uplink resource allocation; and transmitting the plurality of packets to the base station based on at least one of the first priority or the second priority.

In the determining of whether the at least one delay-critical packet is present, the at least one processor may cause the terminal to perform: comparing a remaining delay time of a timer corresponding to each of the plurality of packets with the remaining delay time reference; and based on at least one remaining delay time among the plurality of timer remaining delay times being smaller than the remaining delay time reference, determining that the at least one delay-critical packet is present among the plurality of packets, and based on at least one remaining delay time among the plurality of timer remaining delay times not being smaller than the remaining delay time reference, determining that the at least one delay-critical packet is not present among the plurality of packets.

In determining of whether the at least one delay-critical packet is present, the at least one processor may cause the terminal to perform: receiving, from the base station, information on a pdu-SetDiscard field for a protocol data unit (PDU) set; and based on a remaining delay time of at least one of packets having an identical PDU set sequence number (SN) being smaller than the remaining delay time reference, determining, according to the pdu-SetDiscard field, that the at least one delay-critical packet is present among the plurality of packets, and based on a remaining delay time of at least one of packets having an identical PDU set SN being not smaller than the remaining delay time reference, determining, according to the pdu-SetDiscard field, that the at least one delay-critical packet is not present among the plurality of packets.

In the determining of whether the at least one delay-critical packet is present, the at least one processor may cause the terminal to perform: receiving, from the base station, information on an mMPDU-SetDiscard field for a multi-modality (MM) PDU set; and based on a remaining delay time of at least one of packets having an identical multi-modality PDU set SN being smaller than the remaining delay time reference, determining, according to the mMPDU-SetDiscard field, that the at least one delay-critical packet is present among the plurality of packets, and based on a remaining delay time of at least one of packets having an identical multi-modality PDU set SN not being smaller than the remaining delay time reference, determining, according to the mMPDU-SetDiscard field, that the at least one delay-critical packet is not present among the plurality of packets.

The at least one processor may further cause the terminal to perform: receiving, from the base station, information on a prioritized bit rate (PBR) and a bucket size duration (BSD); determining a bucket (B) size based on at least one of the PBR or the BSD; based on the bucket size being greater than 0, allocating first-stage uplink resources to at least one packet among the plurality of packets of the logical channel, the at least one packet corresponding to a range of the bucket size; decreasing the bucket size based on a size of the allocated first-stage uplink resources; and allocating second-stage uplink resources to each of remaining packets of the logical channel.

According to the present disclosure, a terminal can determine whether a received packet is a delay-critical packet based on a remaining delay time of the received packet for an XR service, and when the packet is determined to be the delay-critical packet, can allocate a resource for packet transmission by applying a high priority to a logical channel. Accordingly, the terminal can improve efficiency of managing QoS required in the XR service supporting multi-modality.

Furthermore, the terminal can trigger a delay status reporting event for each logical channel based on the remaining delay time of the received packet for the XR service, and can transmit, to a base station, a delay status reporting message for the logical channel based on the event. Accordingly, the terminal can transmit the delay status reporting message to the base station at a time when the delay-critical packet occurs, thereby improving efficiency of managing QoS required in the XR service supporting multi-modality.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating a structure of a control plane protocol of a communication network.

FIG. 4 is a conceptual diagram illustrating a structure of a user plane protocol of a communication network.

FIG. 5 is a flowchart illustrating an exemplary embodiment of a method for managing XR service quality of a base station.

FIG. 6 is a flowchart illustrating another exemplary embodiment of a method for managing XR service quality of a base station.

FIG. 7 is a conceptual diagram illustrating an exemplary embodiment of a method of reporting a delay status per logical channel group of a communication node.

FIG. 8 is a conceptual diagram illustrating another exemplary embodiment of a method of reporting a delay status per logical channel group of a communication node.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or as a phrase including “in response to ˜”. In other words, a phrase including “when ˜” may be interpreted as being the same as or similar to a phrase including “based on ˜” or a phrase including “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

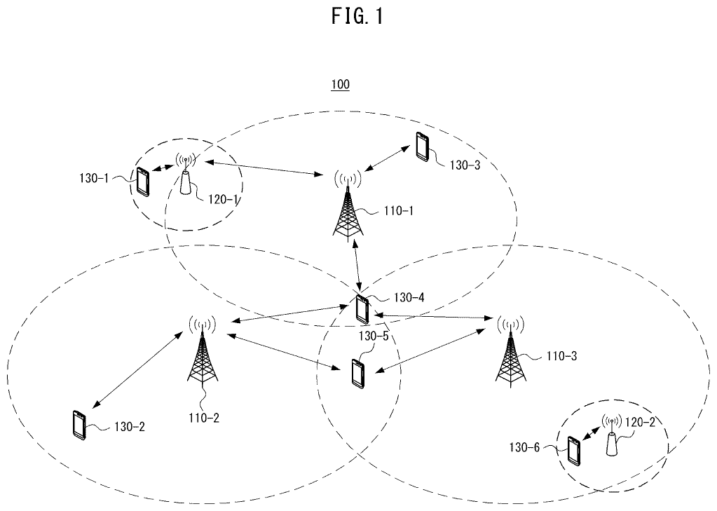

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

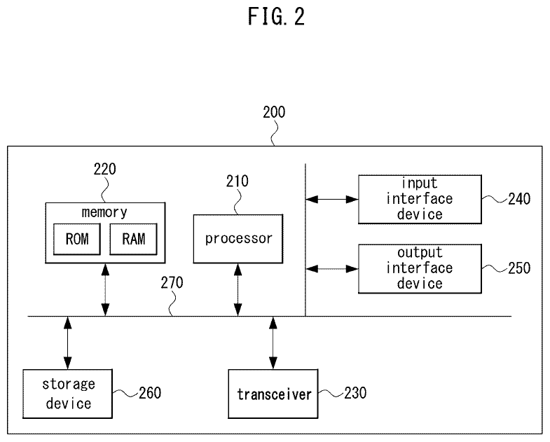

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

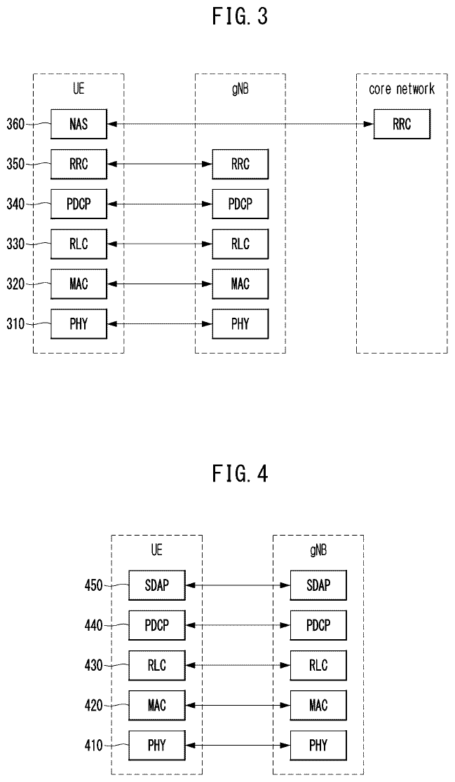

FIG. 3 is a conceptual diagram illustrating a structure of a control plane protocol of a communication network.

Referring to FIG. 3, a radio access protocol of a communication network may provide a function for enabling each of a plurality of communication nodes constituting the communication network to exchange data or control information by utilizing radio resources. A control plane protocol of the radio access protocol may include a first radio layer (RL 1), a second radio layer (RL 2), and a third radio layer (RL 3).

The first radio layer may include a physical (PHY) layer 310. The PHY layer 310 may map data (or packets) received from the second radio layer to a physical channel and may transmit the data on a radio interface, or may perform baseband processing on a radio signal received through the radio interface and may deliver the radio signal to the second radio layer.

The second radio layer may include a medium access control (MAC) layer 320, a radio link control (RLC) layer 330, and a packet data convergence protocol (PDCP) layer 340. The MAC layer 320 may provide at least one of a logical channel and transport channel mapping function, an error correction function through hybrid ARQ (HARQ), or a priority handling function for logical channels allocated to a same user. The PDCP layer 340 may perform addition of MAC-I, ciphering, PDCP header generation, and the like for a Protocol Data Unit (PDU) received from the third radio layer. The PDCP layer 340 may transmit the PDCP PDU to the RLC layer 330. The RLC layer 330 may be located above the MAC layer 320 and may provide a function of performing transmission error control and retransmission.

The third radio layer may include a radio resource control (RRC) layer 350. The RRC layer 350 may provide a function of controlling radio resources including codes, frequencies, or power between a user equipment (UE) and a base station (gNB). For example, the RRC layer 350 may provide a function of controlling physical channels, transport channels, and logical channels for configuration, reconfiguration, and release of a radio bearer. Here, the radio bearer may refer to a logical path provided by the first radio layer and the second radio layer for delivering data between the UE and the gNB. Generally, configuration of a radio bearer may refer to a process of defining characteristics of radio protocol layers and channels required for providing a specific service and configuring concrete parameters and operation methods of the radio protocol layers and the channels.

The control plane protocol may include a non-access stratum (NAS) layer 360. The NAS layer 360 may be located in the UE and a core network, and may provide a function of transmitting and receiving a control message to and from the gNB. The NAS layer 360 may provide a mobility management function, a call control management function, a session management function, an ID management function, and the like. The mobility management may be a function of maintaining a connection and session of a UE moving in a mobility state, the call control management may be a function of establishing, maintaining, or releasing a connection for a voice call and a data service, and the session management may be a function of managing establishment, maintenance, or termination of a communication link. The ID management may be a function of managing identification information of a user and a device.

FIG. 4 is a conceptual diagram illustrating a structure of a user plane protocol of a communication network.

A user plane protocol of the radio access protocol may include a first radio layer and a second radio layer. The first radio layer may include a PHY layer 410. The second radio layer may include a MAC layer 420, an RLC layer 430, a PDCP layer 440, and a service data adaptation protocol (SDAP) layer 450.

The PHY layer 410, the MAC layer 420, and the RLC layer 430 of the user plane protocol may perform substantially same functions as the PHY layer 310, the MAC layer 320, and the RLC layer 330 of the control plane protocol described with reference to FIG. 3.

The SDAP layer 450 may provide a function relating to mapping between a quality of service (QoS) flow and a data radio bearer, and marking of a QoS flow or an ID (QFI) in a downlink packet and an uplink packet. The PDCP layer 440 may perform ciphering and PDCP header generation for data received from the SDAP layer 450 and may transmit a PDCP PDU to the RLC layer 430.

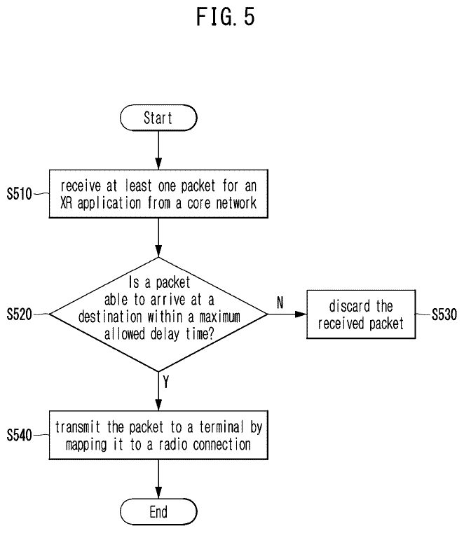

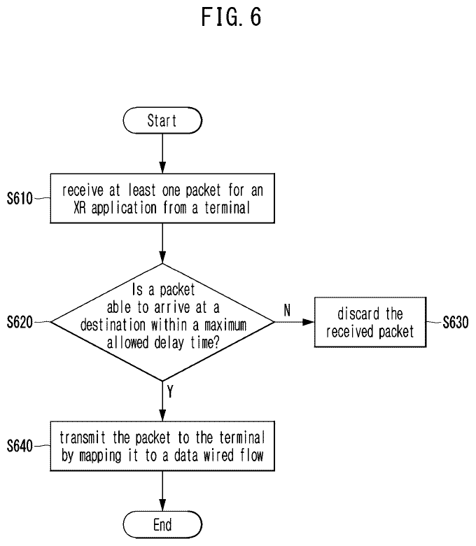

FIG. 5 is a flowchart illustrating an exemplary embodiment of a method for managing XR service quality of a base station, and FIG. 6 is a flowchart illustrating another exemplary embodiment of a method for managing XR service quality of a base station.

A plurality of communication nodes of a communication network may perform QoS management for an extended reality (XR) service. Hereinafter, with reference to FIG. 5 and FIG. 6, a method of service quality management of a base station among the plurality of communication nodes of the communication network is described as an example, but another communication node, for example, a terminal, may perform a method corresponding to the service quality management of the base station.

The communication network of the present disclosure may include a plurality of communication nodes for transmission of data (e.g. packets) for the XR service. The plurality of communication nodes may include a terminal, a base station, and a core network (e.g. user plane function (UPF)).

An XR application for providing the XR service in the communication network may be located in the terminal, or may be configured as a separate XR server and connected to the core network. The communication network may deliver data (e.g. packets) for the XR service between the core network and the terminal. The core network and the base station may be connected via a wired interface, and the base station and the terminal may be connected through a radio interface.

Data for the XR service delivered through the communication network may be in a packet form, and service quality characteristics may be assigned to each packet. The service quality characteristics may include at least one of an error rate or a delay time. Based on the service quality characteristics, delay-critical data may be configured as packets for which an allowed arrival time from a source (e.g. XR application in the terminal or XR server) to a destination (e.g. XR application in the XR server or terminal) is limited.

The terminal or the XR server may configure a packet group (e.g. a PDU set) including a plurality of packets. The plurality of packets may correspond to a plurality of PDUs included in the PDU set, respectively. As described above, service quality characteristics may be assigned for each packet, and therefore, the PDU set may include a sequence number (SN) for identification. Therefore, each of the plurality of packets (or PDUs) of the PDU set may include a corresponding PDU set SN.

Referring to FIG. 5, the base station may receive, from the core network, at least one XR packet for the XR application delivered from the XR server (S510). As described above, the XR packet may include delay-critical data based on the service quality characteristics.

The base station may set a maximum allowed delay time for packets based on the delay-critical data of the received packets. The maximum allowed delay time may be set as a time from a time at which a packet is delivered from the XR server to the core network to a time at which the packet is delivered to the terminal through the communication network. According to an exemplary embodiment, the maximum allowed delay time may be set by the XR server.

The base station may set the maximum allowed delay time of packets as a fixed value or may set the maximum allowed delay time for packets as a variable value. For example, when the XR server sets a maximum allowed delay time identical for all packets when setting packet transmission parameters, the base station may set a maximum allowed delay time identical for each packet based on the maximum allowed delay time among transmission parameters received from the core network. The base station may set the same timer value (e.g. discard timer) for each packet based on the set maximum allowed delay time. In addition, the base station may set a different maximum allowed delay time for each packet based on a time at which the base station receives the packet from the core network and a maximum allowed reception time of the packet. For example, the base station may apply a predefined time difference to the maximum allowed reception time and may set the maximum allowed delay time for each packet. The base station may set a different timer for each packet based on the set maximum allowed delay time.

The base station may determine whether the corresponding packet is able to arrive at a destination (e.g. terminal) within the maximum allowed delay time based on the set maximum allowed delay time (S520). When the base station determines that the packet is able to arrive at the terminal within the maximum allowed delay time, the base station may transmit the corresponding packet to the terminal (S540).

The base station may receive the packet from the core network through the wired interface. The base station may map the packet to a radio connection (e.g. data radio bearer (DRB)) between the base station and the terminal based on the determination result described above. The base station may transmit the mapped packet to the terminal through the radio interface. The base station may map the packet to the radio connection in a one-to-one (1:1), one-to-many (1:N or N:1), or many-to-many (N:M) scheme.

When the base station determines that the packet is not able to arrive at the terminal within the maximum allowed delay time, the base station may discard the packet without transmitting the packet (S530). The base station may receive all packets or some packets of a PDU set including a PDU set SN from the core network. When the terminal uses all packets of a PDU set for the XR application, the base station may discard all packets associated with the same PDU set SN in the PDU set based on the determination result. In addition, when the terminal uses only some packets of the PDU set for the XR application, the base station may discard a subset of packets among the plurality of packets of the PDU set based on the determination result.

According to an exemplary embodiment, the XR server may set importance for each of a plurality of packets of a PDU set transmitted to the base station. The XR server may differently set a maximum allowed delay time for each packet based on the set packet importance. The XR server may differently set a priority of allocating radio resources for each packet for packet transmission based on the packet importance.

The XR server may transmit a MAC CE indicating activation or deactivation of the packet importance to the base station. The base station may, when the packet importance is activated based on the received MAC CE, differently set a maximum allowed delay time for each packet, or may differently set a priority of allocating radio resources for packet transmission based on the packet importance. For example, the base station may set a timer (e.g. discardTimerForLowImportance) for a packet having low importance based on the packet importance activated by the received MAC CE. In addition, when pdu-SetDiscard is set together with the timer, the base station may discard all packets associated with the same PDU set SN in a PDU set in a packet discard operation.

Referring to FIG. 6, the base station may receive at least one XR packet for the XR application from the terminal (S610). The XR packet may include delay-critical data based on the service quality characteristics.

The base station may set a maximum allowed delay time for packets based on delay-critical data of the received packets. The base station may set a maximum allowed delay time as a fixed value or may set a maximum allowed delay time as a variable value. The maximum allowed delay time may be a time from a time at which a packet is transmitted from the terminal to the base station to a time at which the packet is transmitted to the XR server (or core network) through the communication network. The maximum allowed delay time may be set at the terminal or at the base station.

The base station may determine whether the corresponding packet is able to arrive at a destination (e.g. XR server) within the maximum allowed delay time based on the set maximum allowed delay time (S620). When the base station determines that the packet is able to arrive at the XR server within the maximum allowed delay time, the base station may transmit the corresponding packet to the core network (S640).

According to an exemplary embodiment, the base station may set, based on the set maximum allowed delay time, a maximum allowed delay time for a radio communication section (e.g. a communication section between the terminal and the base station). The terminal may transmit packets to the base station based on the set maximum allowed delay time. The terminal may perform a procedure of discarding a packet that is determined to be unable to be transmitted to the base station within the maximum allowed delay time.

The base station may receive packets from the terminal through a radio interface. The base station may map the received packets to a wired flow between the base station and the core network based on the determination result described above. The base station may transmit the mapped packets to the core network through the wired interface. The base station may map the packets to the wired flow in a one-to-one (1:1), one-to-many (1:N or N:1), or many-to-many (N:M) scheme.

The terminal may discard a packet without transmitting the packet when the terminal determines that the packet is not able to arrive at the XR server within the maximum allowed delay time (S630). The terminal may transmit all packets or some packets of a PDU set, which include a PDU set SN, to the base station. Here, when the XR server utilizes all packets of the PDU set for the XR application, the terminal may discard all packets associated with the same PDU set SN in the PDU set based on the determination result. In addition, when the XR server utilizes some packets of the PDU set for the XR application, the terminal may discard some packets among the plurality of packets of the PDU set corresponding to the determination result.

The terminal may set importance for each of a plurality of packets of a PDU set transmitted to the base station. The terminal or the base station may differently set a maximum allowed delay time for each packet based on the set packet importance, or may differently set a priority of allocating radio resources for each packet for packet transmission based on the packet importance. When the base station differently sets a maximum allowed delay time for each packet based on the packet importance, the terminal may receive a MAC CE indicating activation or deactivation of the packet importance from the base station. The terminal may differently set a maximum allowed delay time for each packet when the packet importance is activated based on the received MAC CE.

The communication node (e.g. the terminal or the base station) may set a maximum allowed delay time for a packet either by using a fixed maximum allowed delay time or by variably determining the maximum allowed delay time in consideration of a maximum allowed arrival time of the packet. The communication node may determine a fixed maximum allowed delay time in a process of setting transmission-related parameters for packets, may set the maximum allowed delay time for a packet when the packet is received, and may set a timer (i.e. discardTimer) based on the maximum allowed delay time. The communication node may discard a related packet when the set timer expires. The communication node may determine a variable maximum allowed delay time based on a reception time of a packet and a maximum allowed arrival time of the packet. The communication node may set a different maximum allowed delay time for each packet. For example, the communication node may set a time difference between the maximum allowed arrival time and a predetermined time as a maximum allowed delay time for the packet. The communication node may set a timer based on the set maximum allowed delay time.

The communication node may manage QoS for packets included in a PDU set on a radio connection (e.g. a radio connection between the terminal and the base station). The communication node may set a maximum allowed delay time for packets transmitted through the radio connection and, when a packet is received from another communication node, may set a timer (i.e. discardTimer) based on the set maximum allowed delay time. The communication node may transmit the packet to another communication node within the maximum allowed delay time. In this case, the communication node may discard a packet for which the timer has expired or a packet that is unable to be transmitted within the maximum allowed delay time. For example, the communication node may set a remaining time of the timer as a remaining delay time of the packet. The communication node may transmit the corresponding packet to another communication node when the remaining delay time of the packet is greater than 0. The communication node may discard the corresponding packet when the remaining delay time of the packet is 0.

The communication node may set the discard configuration (e.g. pdu-SetDiscard) for packets. In such a case, the communication node may discard all packets associated with the same PDU set SN in the packet discard operation. According to an exemplary embodiment, when a PDU set includes a plurality of packets (e.g. PDUs), the communication node may set a remaining delay time of the PDU set based on remaining delay times of packets included in the PDU set. The communication node may transmit packets included in the PDU set to another communication node when the remaining delay time of the PDU set is greater than 0. The communication node may discard the packets included in the PDU set when the remaining delay time of the PDU set is 0.

The communication node may set importance for a packet. The communication node may set a priority of the packet based on the importance of the packet and may manage QoS of the packet on the radio connection. The communication node may additionally configure a timer (e.g. discardTimerForLowImportance) for setting a maximum allowed delay time for a low-importance priority packet. The communication node may discard a low-importance priority packet when the corresponding timer expires. According to an exemplary embodiment, the base station among the communication nodes may set a PDU set importance indicator for packet importance. The terminal may set separate timers for low-importance packets and high-importance packets based on the indicator. The terminal may receive a signal (e.g. MAC CE) indicating activation or deactivation of the timer(s) from the base station. The terminal may activate one timer among the timer for low-importance packets or the timer for high-importance packets based on the MAC CE and may perform a packet discard operation based on the activated timer.

In the present disclosure, the XR application may be configured as a multi-modality service, and the multi-modality service may be distinguished based on a multi-modality service identifier (MMSID) representing the service. As described above, the XR application may be located in the terminal or the XR server and may configure the multi-modality service. The XR application may be configured in a server-side communication node and a user-side communication node, and each node may configure the multi-modality service by negotiation. Packets generated by the XR application may be delivered to a counterpart XR application through a communication connection, and communication parameters required for packet delivery may be configured and may be configured for intermediate nodes participating in communication. For example, the core network and the terminal may acquire an identifier or parameters for the multi-modality service from the XR application. The base station of the communication network may receive at least one parameter related to the multi-modality service transmitted from the XR server through the core network by using an NGAP protocol. The base station may receive at least one parameter related to the multi-modality service from the terminal through at least one of an RRC message or UE assistance information (UAI).

The base station may establish a multi-flow with the core network connected through the wired interface to support the multi-modality service, and the base station may receive packets for the XR application from the core network through the multi-flow. The base station may establish a multi-radio bearer with the terminal that is connected through the radio interface to support the multi-modality service, and the base station may receive packets for the XR application from the terminal through the multi-radio bearer. To this end, the base station may map the multi-flow to the multi-radio bearer, and a mapping method may be performed in at least one of the one-to-one, one-to-many, or many-to-many scheme.

The terminal or the XR server may generate packets for the XR application that provides the multi-modality service. A set of a plurality of packets in the XR application may be a multi-modality PDU set (MM PDU set), and a sequence number (SN) may be assigned for each packet of the multi-modality PDU set. In addition, the multi-modality PDU set may include a multi-modality service ID (MMSID) that identifies the multi-modality service. The terminal or the XR server may transmit the plurality of packets included in the multi-modality PDU set to a communication node (e.g. the base station) through a plurality of flows or radio bearers mapped by modality.

The terminal or the XR server may configure a multi-modality PDU set based on multiple PDU sets. Each PDU set may have a different configuration for each of the plurality of flows or radio bearers, and similar characteristics with a set of PDU set SNs may be provided by configuring an association of the respective flows or radio bearers. According to an exemplary embodiment, when periods of a plurality of PDU set SNs are identical and initial values thereof are different, the terminal or the XR server may determine an association with the multi-modality PDU set SN based on a difference between values of the PDU set SNs. For example, a difference between an initial value of a first PDU set in a first flow and an initial value of the first PDU set in a second flow may be 2. In this case, if a difference between initial values of a second PDU set similar to the first PDU set in the first flow and the second flow is 2, the terminal or the XR server may determine that the first PDU set and the second PDU set are associated with a multi-modality PDU set SN (e.g. MM PDU set SN).

The base station may configure an mMPDU-SetDiscard field for a multi-modality PDU set for the terminal. The terminal may determine how packets included in the multi-modality PDU set are associated with a multi-modality PDU-set SN, and may discard all packets associated with the same multi-modality PDU-set SN as the discarded packet. The PDU set SN may be commonly used in a plurality of flows. In other words, when the PDU-set SNs are identical, the multi-modality PDU-set SNs of packets included in the same flow or different flows may be the same. Therefore, when the terminal discards at least one delay-critical packet included in the first PDU set of the first flow, the terminal may also discard packets in a second PDU set that shares the same multi-modality PDU-set SN with the first PDU set, if those packets are associated with the discarded packet(s).

The communication node may include a multi-modality PDU set SN capable of identifying packets having relevance with the multi-modality service in a packet. The communication node may include the multi-modality PDU set SN in a packet that is desired to arrive at an XR application of a destination within an allowed delay time. The communication node may include the multi-modality PDU set SN in packets mapped to flows by modality and transmit the packets to another communication node. The communication node that receives the packets may identify the multi-modality PDU set SN of each of the received packets, and may perform QoS management for the multi-modality service for packets having the identical multi-modality PDU set SN.

The multi-modality PDU set SN may be valid in the multi-modality service and may be used for identifying the multi-modality service. For example, the communication node may establish at least one flow corresponding to the MMSID during a process of establishing the multi-modality. The communication node may determine the identical multi-modality PDU set SN among packets related to the established flow, and may perform QoS management for the multi-modality service based on a result of the determination. For example, the communication node may configure the same MMSID for a first flow and a second flow. Another communication node that receives packets mapped to each of the first flow and the second flow from the communication node may determine that the received packets have the same multi-modality PDU set SN based on the MMSID. According to an exemplary embodiment, the communication node may configure an MMSID and a multi-modality SN together for each of a first flow and a second flow. Another communication node that receives packets mapped to each of the first flow and the second flow from the communication node may determine whether the packets are identical packets based on the MMSID and the multi-modality SN.

The communication node may configure a timer based on a maximum allowed delay time of received packets. The communication node may map a plurality of flows to one radio bearer when the communication node transmits packets to the terminal. The communication node may configure a maximum allowed delay time for packets of each of the plurality of flows, and may configure a timer based on the maximum allowed delay time of each flow. The communication node may configure the timer for packets on a radio interface protocol based on the maximum allowed delay time for each flow.

The communication node may set one maximum allowed delay time for one radio bearer mapped to one flow. In addition, the communication node may set a plurality of maximum allowed delay times for one radio bearer mapped to each of the plurality of flows. For example, the communication node may set two maximum allowed delay times for one radio bearer. One maximum allowed delay time may be a value for configuring a first timer (e.g. discardTimer), and another maximum allowed delay time may be a value for configuring a second timer (e.g. discardTimerForMultiModality).

For example, the base station of the communication node may transmit at least one of the plurality of maximum allowed delay times to the terminal. When the base station transmits a first timer configuration value among the plurality of maximum allowed delay times to the terminal, the terminal may configure the first timer for each of the plurality of packets mapped to one radio bearer based on the first timer configuration value. When the base station transmits the first timer configuration value and a second timer configuration value to the terminal, the terminal may configure one timer or two timers for packets mapped to one radio bearer. For example, the terminal may determine whether to apply the first timer configuration value and the second timer configuration value to each of the plurality of received packets. The terminal may configure a timer according to one of the first timer configuration value or the second timer configuration value for each packet based on a result of the determination. In addition, the terminal may configure the timer according to the first timer configuration value and the timer according to the second timer configuration value for each packet based on the result of the determination. According to an exemplary embodiment, the base station may transmit a MAC CE including at least one bit sequence for activating or deactivating each of the plurality of maximum allowed delay times. The terminal may configure the timer for the packets based on the MAC CE received from the base station.

When a received packet does not satisfy a delay-critical data condition, in other words when the timer configured based on the maximum allowed delay time is expired, the communication node may discard the corresponding packet. For example, when the terminal configures the timer based on the maximum allowed delay time, a MAC CE transmitted from the base station to the terminal may include a multi-modality PDU set field. When the timer for the packet is expired, the terminal may determine an MMSID or a multi-modality PDU set SN of the packet based on the multi-modality PDU set field, and based on a result of the determination, the terminal may discard all associated packets among previously received packets.

The communication node may calculate a remaining time for each packet of the XR application that is received. The remaining time may be a time from a reception time of the packet to the maximum allowed delay time previously configured. The communication node may determine a packet whose remaining time is smaller than a reference value (e.g. remaining time reference) as a delay-critical packet.

According to an exemplary embodiment, the terminal may compare the remaining times of the timers for packets with the remaining time reference. When the remaining time of the timer is smaller than the remaining time reference, the terminal may determine the corresponding packet as a delay-critical packet among the plurality of packets. When the remaining time of the timer is larger than the remaining time reference, the terminal may determine the corresponding packet as a packet that is not delay-critical.

According to an exemplary embodiment, the base station may configure a pdu-SetDiscard field for a PDU set to the terminal. The terminal may determine a packet as a delay-critical packet when the remaining time of at least one packet having the identical PDU set SN among a plurality of packets is smaller than the remaining time reference based on the pdu-SetDiscard field. The terminal may determine the corresponding packet as a packet that is not delay-critical when the remaining time of at least one packet having the identical PDU set SN among the plurality of packets is larger than the remaining time reference.

According to an exemplary embodiment, the base station may configure an mMPDU-SetDiscard field for a multi-modality PDU set to the terminal. The terminal may determine a packet as a delay-critical packet when a remaining delay time of at least one packet having an identical multi-modality PDU set SN among a plurality of packets is smaller than the remaining delay time reference based on the mMPDU-SetDiscard field. The terminal may determine the packet as a packet that is not delay-critical when the remaining delay time of at least one packet having an identical multi-modality PDU set SN among the plurality of packets is larger than the remaining delay time reference.

The communication node may preferentially allocate radio resources to the delay-critical data determined based on the remaining delay time among the plurality of packets. The communication node may reflect a priority in an operation of allocating a logical channel for transmitting the packet, and the priority may be configured based on the remaining delay time described above. The communication node may variably change a scheduling priority of the logical channel for the packet that satisfies a condition of being smaller than the remaining delay time reference (e.g. reference value) among the plurality of packets. The priority or the remaining delay time reference may be configured as an absolute value or may be configured as a difference value from a reference value.

For example, the base station may allocate a first logical channel and a second logical channel to the terminal. The base station may configure a first priority for the first logical channel, and may configure a second priority and a remaining delay time reference for the second logical channel. The terminal may receive a plurality of packets from the base station and may store the packets in a buffer. When a remaining delay time of packets located in the buffer is smaller than the remaining delay time reference, the terminal may determine the packets as delay-critical packets. The terminal may change the priority of the second logical channel to be higher than the priority of the first logical channel. The terminal may preferentially allocate radio resources for packet transmission (e.g. uplink radio resources) to the second logical channel.

According to an exemplary embodiment, the base station may configure a priority of a logical channel when allocating radio resources based on a remaining delay time of a packet that changes in real time. For example, the base station may allocate a first logical channel, a second logical channel, and a third logical channel to the terminal. The base station may configure a first priority for the first logical channel, may configure a second priority and a second remaining delay time reference for the second logical channel, and may configure a third priority and a third remaining delay time reference for the third logical channel. The terminal may receive a plurality of packets from the base station, and may determine packets as delay-critical packets when a remaining delay time of the packets stored in the buffer is smaller than the second remaining delay time reference. In addition, the terminal may identify that the remaining delay time of packets becomes smaller than the third remaining delay time reference as time elapses. The terminal may change the priority of the second logical channel to be higher than the priority of the first logical channel at a time at which the remaining delay time of the packets become smaller than the second remaining delay time reference. In addition, the terminal may change the priority of the third logical channel to be higher than the priority of the second logical channel at a time at which the remaining delay time of the packets become smaller than the third remaining delay time reference.

According to an exemplary embodiment, the base station may configure a plurality of priorities for a logical channel allocated to the terminal. For example, the base station may configure a first priority as a basic priority and may configure a second priority as an additional priority for the logical channel of the terminal. In addition, the base station may configure a condition for activating the second priority. For example, the base station may configure a remaining delay time reference together with the second priority, and may configure a condition for activating the second priority based on the remaining delay time reference. When a remaining delay time of packets located in the buffer is smaller than the remaining delay time reference, the terminal may determine the packets as delay-critical packets. The terminal may activate the second priority and may preferentially allocate radio resources for the second priority to the logical channel.

When the terminal allocates radio resources to the logical channel, the terminal may consider a prioritized bit rate (PBR) or a bucket size duration (BSD). The terminal may periodically calculate a bucket size (B). B after a periodic interval may be calculated based on Equation 1 described below.

$$B\_next = B + PBR \times T \qquad [ Equation 1 ]$$

The maximum value of B may be determined based on Equation 2 described below.

$$B max = PBR \times BSD \qquad [ Equation 2 ]$$

When the value of B is greater than 0, the terminal may allocate radio resources to the logical channel and may transmit packets. The terminal may decrease B by a size of the transmitted packets.

The terminal may independently allocate radio resources for each priority of the logical channel. The terminal may set PBR_p and BSD_p for a priority P of the logical channel. The terminal may periodically calculate B_p for the logical channel. The terminal may decrease B_p by a size of packets transmitted based on the priority.

According to an exemplary embodiment, the base station may set PBR_0 and BSD_0 for the first priority of the logical channel and may set a remaining delay time reference PBR_1 and BSD_1 for the second priority. When a received packet does not satisfy the remaining delay time reference, the terminal may assign the first priority to the logical channel. When the packet satisfies the remaining delay time reference, in other words when the packet is determined as a delay-critical packet, the terminal may assign the second priority to the logical channel. The terminal may allocate radio resources by using B_0 during a time duration in which the first priority is assigned to the logical channel. The terminal may allocate radio resources by using B_1 during a time duration in which the second priority is assigned to the logical channel.

The terminal may store a plurality of packets received from the base station in a buffer in the order in which they are received, and may transmit the packets to a counterpart communication node in the same order. The terminal may determine whether a remaining delay time condition for each packet is satisfied at a specific time, and may determine packets that satisfy the remaining delay time condition as delay-critical data among the plurality of stored packets. As described above, the terminal may change a priority of the packets determined as the delay-critical packets. The buffer of the terminal may include a mixture of delay-critical packets and general packets. Therefore, when the terminal transmits the packets stored in the buffer in the order stored in the buffer, a situation may occur in which a general packet is transmitted through radio resources allocated based on the priority due to the delay-critical packets.

For example, three packets are stored in the buffer of the terminal, and remaining times of the three packets are 5 ms, 20 ms, and 7 ms, and the remaining delay time reference is configured as 10 ms. The terminal may determine two packets having remaining times of 5 ms and 7 ms as delay-critical packets based on the remaining delay time reference. The terminal may increase the priority of the logical channel of the two packets. The terminal may transmit the packets in the buffer to the base station in the order stored in the buffer. In this case, since the priority of the logical channel is increased until a time at which the packet having a remaining time of 7 ms is transmitted, the packet having a remaining time of 20 ms may be transmitted through radio resources allocated at a higher priority.

Therefore, the terminal may reorder the packets stored in the buffer based on the changed priority. For example, when three packets having remaining times of 5 ms, 20 ms, and 7 ms are stored in order in the buffer, the terminal may reorder the three packets in the order of remaining times of 5 ms, 7 ms, and 20 ms based on the changed priority according to the remaining delay time condition. The terminal may allocate radio resources to each of the three packets stored in the buffer based on the priority. The terminal may transmit the corresponding packets to another communication node by using the allocated radio resources. The terminal may decrease a size of B_p by a size of the transmitted packets after transmitting the packets.

According to an exemplary embodiment, the base station may configure a first priority for a logical channel of the terminal and additionally configure a second priority for delay-critical data. The terminal may calculate B for each period based on at least one of PBR or BSD configured for the logical channel. The terminal may allocate radio resources to the logical channel by using B of the first priority for general packets, in other words packets that do not satisfy the remaining delay time reference. The terminal may allocate radio resources to the logical channel by using B of the second priority for packets that satisfy the remaining delay time reference (e.g. delay-critical packets). Here, B of the second priority may be decreased by a size of the transmitted packets, and may be configured as a value smaller than 0. For example, the terminal may configure a maximum transmittable data amount K for the delay-critical data. The terminal may limit radio resources allocated to packets during a time duration in which the second priority is applied to Min (B, K). Here, when B is smaller than K, a value of B after the packets are transmitted may be calculated as B-K.

According to an exemplary embodiment, when delay-critical packets are not stored in the buffer for the logical channel of the terminal, the terminal may assign the first priority for the packets. The terminal may allocate radio resources to each packet based on a value of B that is calculated based on the first priority. The terminal may allocate radio resources for transmitting packets within a range of the value of B (step 1), and B after the radio resources are allocated may be decreased by an amount of the transmitted resources so that the value of B may become smaller than 0. The terminal may allocate radio resources to each of remaining packets within a range of allocatable radio resources (step 2).

According to an exemplary embodiment, when delay-critical packets are stored in the buffer for the logical channel, the terminal may assign the second priority for the delay-critical packets. The terminal may allocate radio resources to the delay-critical packets based on a value of B that is calculated based on the second priority. The terminal may allocate radio resources to the delay-critical packets among all packets based on the value of B (step 1), and may allocate radio resources to remaining packets within a range of allocatable radio resources (step 2).

For example, when delay-critical packets exist in the logical channel, the terminal may apply the second priority in the radio resource allocation of step 1 and may apply the first priority in the radio resource allocation of step 2. The first priority may be a general priority. The second priority may be a priority that assigns a higher rank for the delay-critical packets.

According to an exemplary embodiment, the base station may configure a first priority, a second priority, and a remaining delay time reference for a logical channel of the terminal. When a remaining delay time of a preconfigured timer discardTimer for packets is smaller than the remaining delay time reference, the terminal may determine the packets as delay-critical packets and may determine that the delay-critical packets exist in the logical channel. Here, the terminal may determine the existence of the delay-critical packets by comparing a PDU set remaining delay time of the packets with the remaining delay time reference. The terminal may apply the second priority having a higher rank for the delay-critical packets and may allocate radio resources to the delay-critical packets based on the value of B. The terminal may allocate radio resources to the delay-critical packets among all packets based on the value of B (step 1). The terminal may apply the second priority when delay-critical packets exist among the remaining packets, and may apply the first priority when delay-critical packets do not exist among the remaining packets. The terminal may allocate radio resources to each of the remaining packets within a range of allocatable radio resources based on the applied priority (step 2).

According to an exemplary embodiment, when a PBR value is configured as a specific value, the terminal may allocate radio resources to each of the plurality of packets within a range of the value of B (step 1). When remaining packets exist in the same logical channel, the terminal may uniformly allocate the radio resources to the logical channel.

The base station may configure a first priority and a second priority for a logical channel of the terminal. The terminal may allocate radio resources to packets based on the first priority and the second priority for the logical channel. When the terminal allocates radio resources to packets based on the second priority, the terminal may receive maximum transmittable data amount configuration information (e.g. K) from the base station. The terminal may limit radio resources that are allocated according to the second priority based on the value of K.

The terminal may transmit buffer information required for scheduling (e.g. delay status report (DSR) on a delay state of packets) to the base station. The base station may configure a remaining delay time reference Tc and a transmission prohibit timer Tp for transmitting the DSR message of the terminal. The terminal may transmit a DSR message including a minimum remaining delay time and a buffer size for the delay-critical packets to the base station. In order to reduce a transmission number of the DSR message, the terminal may omit transmission of the DSR message during a time duration in which the transmission prohibit timer configured by the base station operates.

The terminal may distinguish the buffer in which packets are stored into a plurality of sections and may transmit a DSR message for each section to the base station. The base station may configure a remaining delay time reference for each of the plurality of sections to the terminal. When a remaining delay time of packets included in an i-th section among the plurality of sections of the buffer is included within a range of a remaining delay time of the section (e.g. (Tc_i−1, Tc_i)), the terminal may transmit, as the DSR message, a sum of sizes of the packets of the section and a minimum value of remaining delay times of the packets of the section.

The terminal may periodically determine a buffer state based on the remaining delay time reference configured by the base station. The terminal may transmit the DSR message including a buffer size of each of the plurality of sections, in other words a sum of sizes of packets of each section, and a minimum remaining delay time of each section, to the base station based on the buffer state. The terminal may transmit the DSR message to the base station through a MAC CE. The DSR MAC CE may include at least one field among a section index of the buffer, a size (or a sum of packet sizes) of each section, or a minimum remaining delay time of each section. The terminal may transmit the DSR MAC CE to the base station when a buffer state of each section changes or when a buffer size is changed by equal to or greater than a preconfigured value.

According to an exemplary embodiment, the base station may configure a remaining delay time reference as 5 ms and may transmit the remaining delay time reference to the terminal. Based on the received remaining delay time reference, the terminal may transmit, to the base station, a DSR MAC CE including a sum of sizes of at least one packet having a remaining delay time corresponding to 0 to 5 ms and a sum of sizes of at least one packet having a remaining delay time equal to or greater than 5 ms among packets stored in the buffer. The DSR MAC CE may include two buffer size fields. The terminal may configure the sum of sizes of at least one packet having a remaining delay time corresponding to 0 to 5 ms in the first buffer size field and may configure the sum of sizes of at least one packet having a remaining delay time equal to or greater than 5 ms in the second buffer size field.

According to an exemplary embodiment, the base station may configure a remaining delay time reference as 5 ms and may transmit the remaining delay time reference to the terminal. Based on the received remaining delay time reference, the terminal may transmit, to the base station, a DSR MAC CE including a minimum remaining delay time of at least one packet having a remaining delay time corresponding to 0 to 5 ms and a minimum remaining delay time of at least one packet having a remaining delay time equal to or greater than 5 ms among packets stored in the buffer. The DSR MAC CE may include two minimum remaining delay time fields. The terminal may configure the minimum remaining delay time of at least one packet having a remaining delay time corresponding to 0 to 5 ms in the first minimum remaining delay time field and may configure the minimum remaining delay time of at least one packet having a remaining delay time equal to or greater than 5 ms in the second buffer size field.

According to an exemplary embodiment, the base station may configure a remaining delay time reference as 5 ms and may transmit the remaining delay time reference to the terminal. Based on the received remaining delay time reference, the UE may transmit, to the base station, a DSR MAC CE including a sum of sizes of at least one packet having a remaining delay time corresponding to 0 to 5 ms and a minimum remaining delay time, and a sum of sizes of at least one packet having a remaining delay time equal to or greater than 5 ms and a minimum remaining delay time, among packets stored in the buffer. The DSR MAC CE may include two buffer size fields and two minimum remaining delay time fields. The terminal may configure the minimum remaining delay time and the sum of packet sizes of at least one packet having a remaining delay time corresponding to 0 to 5 ms in the first minimum remaining delay time field and the first buffer size, respectively. The terminal may configure the minimum remaining delay time and the sum of packet sizes of at least one packet having a remaining delay time equal to or greater than 5 ms in the second minimum remaining delay time field and the second buffer size field, respectively.

The base station may configure a report remaining time indicating a DSR time of the terminal and a plurality of remaining delay time ranges indicating a plurality of delay time sections to the terminal. When remaining delay times of packets stored in the buffer are equal to or smaller than the report remaining time, the terminal may transmit a DSR MAC CE to the base station. The terminal may transmit the DSR MAC CE to the base station by using uplink radio resources allocated from the base station. The terminal may configure the DSR MAC CE as a multiple entry DSR MAC CE and may transmit the multiple entry DSR MAC CE to the base station through a MAC layer. When the base station does not allocate uplink radio resources for transmitting the DSR MAC CE to the terminal, the terminal may transmit a scheduling request (SR) for requesting allocation of uplink radio resources to the base station.

When the terminal configures the multiple entry DSR MAC CE, the terminal may configure a plurality of report sections for the buffer based on the plurality of remaining delay time ranges configured by the base station. For example, the terminal may configure a remaining delay time range for an i-th section among the plurality of sections of the buffer as (Tc_i−1, Tc_i). The terminal may determine a minimum remaining delay time for at least one packet in the delay time range of the i-th section of the buffer and may determine a sum of sizes of the packets. The terminal may configure the multiple entry DSR MAC CE including a buffer size of the section according to the minimum remaining delay time and the sum of packet sizes for the i-th section. In addition, when the remaining delay time of the packet of the i-th section includes 0, the terminal may determine a buffer size including a control message.

The terminal may configure a buffer size field for packets in a PDCP layer. The buffer size field may indicate a size of packets in a form of delay-critical PDCP SDUs. The buffer size field may indicate a size of packets in a form of delay-critical PDCP PDUs. Here, when a PDCP PDU was not transmitted, a PDCP SDU and a PDCP PDU may include a packet that was not reported to the base station.

According to an exemplary embodiment, the base station may configure a dsr-ReportNonDelayCriticalData field for the terminal. The terminal may configure a sum of sizes of at least one packet that does not correspond to a remaining delay time range in at least one of a plurality of logical channels in the buffer size field based on the dsr-ReportNonDelayCriticalData field. Here, a packet that does not correspond to the remaining delay time range may be a packet that is not delay-critical.

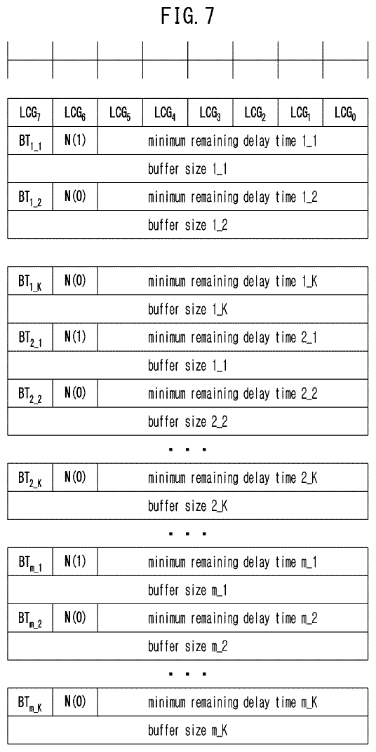

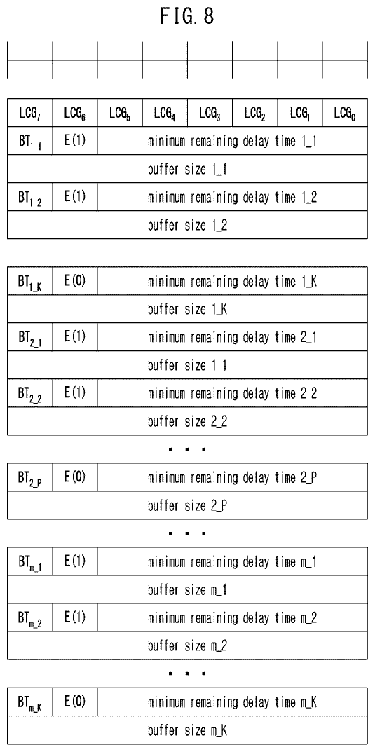

FIG. 7 is a conceptual diagram illustrating an exemplary embodiment of a method of reporting a delay status per logical channel group of a communication node, and FIG. 8 is a conceptual diagram illustrating another exemplary embodiment of a method of reporting a delay status per logical channel group of a communication node.

Referring to FIG. 7 and FIG. 8, a communication node (e.g. terminal) may transmit a delay status report (DSR) message for each logical channel group (LCG) to the base station. The terminal may transmit the DSR message to the base station through a MAC CE. The DSR MAC CE may include at least one minimum remaining delay time field and at least one buffer size field for each LCG. The minimum remaining delay time field may include a minimum remaining delay time for packets that satisfy a remaining delay time reference of buffer information transmitted from the base station. The buffer size field may include a sum of sizes of packets that satisfy the minimum remaining delay time reference. In addition, the DSR MAC CE may include a bit sequence of an identifier (LCG) indicating whether DSR reporting per LCG is present.

For example, a first logical channel group (LCG_0) for a buffer of the terminal may include a 10 byte packet having a remaining delay time of 3 ms, a 20 byte packet having a remaining delay time of 5 ms, and a 40 byte packet having a remaining delay time of 20 ms. The base station may configure the remaining delay time reference as 10 ms for the LCG_0 of the terminal and may transmit the remaining delay time reference to the terminal.

The terminal may configure existence of a field for reporting the DSR for the LCG_0 through an identifier bit sequence of the DSR MAC CE based on the received remaining delay time reference. The terminal may configure 3 ms, which is a minimum remaining delay time among two packets having a remaining delay time corresponding to 0 to 10 ms, in a first minimum remaining delay time field of the DSR MAC CE based on the buffer information. The terminal may configure a sum of sizes of the two packets described above (e.g. 30 bytes) in a first buffer size field. The terminal may configure 20 ms, which is a minimum remaining delay time of remaining packets having a remaining delay time equal to or greater than 10 ms, in a second minimum remaining delay time field based on the buffer information. The terminal may configure a size of the remaining packet described above (e.g. 40 bytes) in a second buffer size field.

As illustrated in FIG. 7, the terminal may transmit the DSR MAC CE including the plurality of minimum remaining delay time fields and the plurality of buffer size fields for each LCG to the base station. An LCGᵢ field of the DSR MAC CE may be a field indicating the presence of fields for reporting the DSR for an i-th LCG. A BT_{m_K} field may be a field indicating a table identifier that refers to a K-th buffer size in an m-th LCG that indicates the presence of the DSR reporting through the LCG; field. An N field may be a field indicating a start of a new LCG. For example, the N field may be configured to 1 to indicate that a new LCG starts, and may be configured to 0 to indicate that an existing LCG is maintained. A minimum remaining delay time field (e.g. Remaining Time_{m_K}) may be a field indicating a K-th minimum remaining delay time in the m-th LCG. A buffer size field (e.g. Buffer Size_{m_K}) may be a field indicating a K-th buffer size in the m-th LCG.

The terminal may omit at least one LCG that does not have a field for reporting the DSR among the plurality of LCGs in the DSR MAC CE. According to an exemplary embodiment, the base station may configure a plurality of remaining delay time references for each of the plurality of LCGs.

As illustrated in FIG. 8, the terminal may transmit the DSR MAC CE including the plurality of minimum remaining delay time fields and the plurality of buffer size fields for each LCG to the base station. The DSR MAC CE illustrated in FIG. 8 may be substantially identical to the DSR MAC CE of FIG. 7 except that an E field is included instead of the N field illustrated in FIG. 7.

For example, an LCGᵢ field of the DSR MAC CE illustrated in FIG. 8 may be a field indicating the presence of fields for reporting the DSR for the i-th LCG. A BT_{m_K} field may be a field indicating a table identifier that refers to the K-th buffer size in the m-th LCG that indicates the presence of the DSR reporting through the LCG; field. An E field may be a field indicating an extension of a reporting pair of the minimum remaining delay time field and the buffer size field for each LCG. For example, when a value of the E field is configured to 1, a reporting pair of the minimum remaining delay time field and the buffer size field may be added in the LCG. When the value of the E field is configured to 0, the E field may indicate that the reporting pair of the minimum remaining delay time field and the buffer size field is last in the LCG. A minimum remaining delay time field (e.g. Remaining Time_{m_K}) may be a field indicating a K-th minimum remaining delay time in the m-th LCG. A buffer size field (e.g. Buffer Size_{m_K}) may be a field indicating a K-th buffer size in the m-th LCG.

The base station may configure a reporting threshold region for the DSR of the terminal. The base station may transmit threshold region information to the terminal. The terminal may configure the DSR MAC CE based on the threshold region information. The terminal may calculate a buffer size (e.g. data volume) corresponding to the threshold region based on the threshold region information. The terminal may calculate at least one data volume in a region configured for each logical channel of the LCG. The terminal may configure a buffer size field of the DSR MAC CE by summing the calculated data volumes. The terminal may configure a minimum remaining delay time field of the DSR MAC CE based on a minimum remaining delay time of data used for calculating the data volume.

The base station may configure a report remaining time for a generation time of the DSR MAC CE of the terminal. The base station may transmit the report remaining time to the terminal. When a remaining delay time calculated for each logical channel included in the LCG becomes smaller than the report remaining time, the terminal may generate a DSR generation event. The terminal may perform a procedure of generating the DSR MAC CE at a time at which uplink radio resources are allocated from the base station based on the DSR generation event.

When the terminal does not generate the DSR MAC CE at the time at which the uplink resources are allocated, the terminal may request allocation of uplink resources by transmitting a scheduling request for additional allocation of uplink resources to the base station. The terminal may transmit one DSR MAC CE to the base station, or may transmit a plurality of DSR MAC CEs to the base station by using the allocated uplink radio resources.

When one threshold region is configured from the base station, the terminal may generate a single entry DSR MAC CE after a DSR generation event occurs and may transmit the single entry DSR MAC CE to the base station. When a plurality of threshold regions are configured from the base station, the terminal may generate a multiple entry DSR MAC CE after a DSR generation event occurs and may transmit the multiple entry DSR MAC CE to the base station.

When a condition for occurrence of the DSR generation event, in other words a condition that a remaining delay time of packets for each logical channel becomes smaller than a reference time, is cleared, the terminal may cancel the DSR generation event. The terminal may cancel the DSR generation event when DSR-related PDCP SDUs are discarded or all transmitted. When the terminal transmits the DSR MAC CE in a MAC PDU, the terminal may cancel the DSR generation event at a time at which all DSR-related PDCP data are expected to be included in the MAC PDU and transmitted. The cancellation of the DSR generation event by the terminal may mean termination of the event, and the event may not operate in the future.

When the terminal cancels the DSR generation event due to DSR-related PDCP SDUs being discarded or all transmitted, the terminal may define the DSR-related PDCP SDU as time critical data, or may include a delay status in the DSR-related PDCP SDU.

According to an exemplary embodiment, the terminal may define an entire PDCP SDU as a DSR-related PDCP SDU. The terminal may classify both time critical data and non-time critical data of the entire PDCP SDU as the DSR-related PDCP SDU and may process the time critical data and the non-time critical data in the DSR generation event. The terminal may transmit information of the time critical data and the non-time critical data of the PDCP SDU to the base station through the DSR MAC CE, or may discard the time critical data and the non-time critical data.

When information on the time critical data of the PDCP SDU is transmitted to the base station through the DSR MAC CE, the terminal may not transmit information on the non-time critical data (e.g. delay status report) for the PDCP SDU. In addition, when information on the time critical data of the PDCP SDU is transmitted to the base station through the DSR MAC CE, the terminal may cancel the DSR generation event. The terminal may not transmit a report for information on the non-time critical data of the PDCP SDU.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, information on a first priority, a second priority, and a remaining delay time reference for a logical channel;
configuring a timer (discardTimer) for each of a plurality of packets received from a higher layer;
determining whether at least one delay-critical packet is present among the plurality of packets based on the remaining delay time reference;
based on the at least one delay-critical packet not being present, applying the first priority to uplink resource allocation, and based on the at least one delay critical packet being present, applying the second priority to the uplink resource allocation; and
transmitting the plurality of packets to the base station based on at least one of the first priority or the second priority.

2. The method of claim 1, wherein the determining of whether the at least one delay-critical packet is present comprises:
comparing a remaining delay time of a timer corresponding to each of the plurality of packets with the remaining delay time reference; and
based on at least one remaining delay time among the plurality of timer remaining delay times being smaller than the remaining delay time reference, determining that the at least one delay-critical packet is present among the plurality of packets, and based on at least one remaining delay time among the plurality of timer remaining delay times not being smaller than the remaining delay time reference, determining that the at least one delay-critical packet is not present among the plurality of packets.

3. The method of claim 1, wherein the determining of whether the at least one delay-critical packet is present comprises:
receiving, from the base station, information on a pdu-SetDiscard field for a protocol data unit (PDU) set; and
based on a remaining delay time of at least one of packets having an identical PDU set sequence number (SN) being smaller than the remaining delay time reference, determining, according to the pdu-SetDiscard field, that the at least one delay-critical packet is present among the plurality of packets, and based on a remaining delay time of at least one of packets having an identical PDU set SN being not smaller than the remaining delay time reference, determining, according to the pdu-SetDiscard field, that the at least one delay-critical packet is not present among the plurality of packets.

4. The method of claim 1, wherein the determining of whether the at least one delay-critical packet is present comprises:
receiving, from the base station, information on an mMPDU-SetDiscard field for a multi-modality (MM) PDU set; and
based on a remaining delay time of at least one of packets having an identical multi-modality PDU set SN being smaller than the remaining delay time reference, determining, according to the mMPDU-SetDiscard field, that the at least one delay-critical packet is present among the plurality of packets, and based on a remaining delay time of at least one of packets having an identical multi-modality PDU set SN not being smaller than the remaining delay time reference, determining, according to the mMPDU-SetDiscard field, that the at least one delay-critical packet is not present among the plurality of packets.

5. The method of claim 1, further comprising:
receiving, from the base station, information on a prioritized bit rate (PBR) and a bucket size duration (BSD);
determining a bucket (B) size based on at least one of the PBR or the BSD;
based on the bucket size being greater than 0, allocating first-stage uplink resources to at least one packet among the plurality of packets of the logical channel, the at least one packet corresponding to a range of the bucket size;
decreasing the bucket size based on a size of the allocated first-stage uplink resources; and
allocating second-stage uplink resources to each of remaining packets of the logical channel.

6. The method of claim 5, wherein the allocating of the first-stage uplink resources comprises: allocating the first-stage uplink resources by applying the second priority, and the allocating of the second-stage uplink resources comprises: based on the at least one delay-critical packet being present among the remaining packets, allocating the second-stage uplink resources by applying the second priority; and based on the at least one delay-critical packet not being present among the remaining packets, allocating the second-stage uplink resources by applying the first priority.

7. The method of claim 5, wherein the allocating of the first-stage uplink resources comprises: based on the PBR being configured as a specific value, allocating the first-stage uplink resources to each of the plurality of packets, and the allocating of the second-stage uplink resources comprises: uniformly allocating the second-stage uplink resources to a same logical channel.

8. The method of claim 1, further comprising: transmitting, to the base station, a delay status report (DSR) message including delay time information for each of the plurality of packets.

9. A method of a terminal, comprising:
receiving, from a base station, information on a report remaining time indicating a delay status report (DSR) time for each logical channel group and information on a plurality of remaining delay time ranges;
based on a remaining delay time of a packet received from a higher layer being equal to or less than the report remaining time, triggering a DSR generation event; and
transmitting a DSR medium access control (MAC) control element (MAC CE) to the base station using uplink resources allocated from the base station.

10. The method of claim 9, wherein the DSR MAC CE includes a minimum remaining delay time field and a buffer size field corresponding to at least one section of the logical channel group, and the transmitting of the DSR MAC CE to the base station comprises:
setting, in the minimum remaining delay time field, a minimum remaining delay time of at least one packet corresponding to a remaining delay time range in at least one logical channel of the logical channel group; and
setting, in the buffer size field, a sum of sizes of the at least one packet.

11. The method of claim 10, wherein the at least one packet includes at least one packet in a packet data convergence protocol (PDCP) service data unit (SDU) format or a PDCP packet data unit (PDU) format.

12. The method of claim 10, wherein the setting of the sum of sizes of the at least one packet in the buffer size field comprises:
receiving, from the base station, information on a dsr-ReportNonDelayCriticalData field; and
based on the dsr-ReportNonDelayCriticalData field, setting, in the buffer size field, a sum of sizes of at least one packet corresponding to a packet that does not correspond to the remaining delay time range in at least one of the plurality of logical channels,
wherein the at least one packet includes at least one packet in a PDCP SDU format or a PDCP PDU format.

13. The method of claim 9, wherein the DSR MAC CE includes an E field indicating an extension of a reporting pair of a minimum remaining delay time field and a buffer size field for each logical channel group, and the transmitting of the DSR MAC CE to the base station comprises: setting a value of the E field to 1 to add a reporting pair of a minimum remaining delay time field and a buffer size field in a logical channel group corresponding to the DSR; and setting the value of the E field to 0 to indicate a last reporting pair in the logical channel group.

14. The method of claim 9, further comprising: based on the uplink resources not being allocated from the base station, transmitting, to the base station, a scheduling request for requesting uplink resource allocation.

15. The method of claim 9, further comprising: based on at least one of packet information or a packet related to the DSR MAC CE being transmitted to the base station, cancelling the DSR generation event.

16. A terminal comprising at least one processor, wherein the at least one processor causes the terminal to perform:
receiving, from a base station, information on a first priority, a second priority, and a remaining delay time reference for a logical channel;
configuring a timer (discardTimer) for each of a plurality of packets received from a higher layer;
determining whether at least one delay-critical packet is present among the plurality of packets based on the remaining delay time reference;
based on the at least one delay-critical packet not being present, applying the first priority to uplink resource allocation, and based on the at least one delay critical packet being present, applying the second priority to the uplink resource allocation; and
transmitting the plurality of packets to the base station based on at least one of the first priority or the second priority.

17. The terminal of claim 16, wherein in the determining of whether the at least one delay-critical packet is present, the at least one processor causes the terminal to perform:
comparing a remaining delay time of a timer corresponding to each of the plurality of packets with the remaining delay time reference; and
based on at least one remaining delay time among the plurality of timer remaining delay times being smaller than the remaining delay time reference, determining that the at least one delay-critical packet is present among the plurality of packets, and based on at least one remaining delay time among the plurality of timer remaining delay times not being smaller than the remaining delay time reference, determining that the at least one delay-critical packet is not present among the plurality of packets.

18. The terminal of claim 16, wherein in the determining of whether the at least one delay-critical packet is present, the at least one processor causes the terminal to perform:
receiving, from the base station, information on a pdu-SetDiscard field for a protocol data unit (PDU) set; and
based on a remaining delay time of at least one of packets having an identical PDU set sequence number (SN) being smaller than the remaining delay time reference, determining, according to the pdu-SetDiscard field, that the at least one delay-critical packet is present among the plurality of packets, and based on a remaining delay time of at least one of packets having an identical PDU set SN being not smaller than the remaining delay time reference, determining, according to the pdu-SetDiscard field, that the at least one delay-critical packet is not present among the plurality of packets.

19. The terminal of claim 16, wherein in the determining of whether the at least one delay-critical packet is present, the at least one processor causes the terminal to perform:
receiving, from the base station, information on an mMPDU-SetDiscard field for a multi-modality (MM) PDU set; and
based on a remaining delay time of at least one of packets having an identical multi-modality PDU set SN being smaller than the remaining delay time reference, determining, according to the mMPDU-SetDiscard field, that the at least one delay-critical packet is present among the plurality of packets, and based on a remaining delay time of at least one of packets having an identical multi-modality PDU set SN not being smaller than the remaining delay time reference, determining, according to the mMPDU-SetDiscard field, that the at least one delay-critical packet is not present among the plurality of packets.

20. The terminal of claim 16, wherein the at least one processor further causes the terminal to perform:
receiving, from the base station, information on a prioritized bit rate (PBR) and a bucket size duration (BSD);
determining a bucket (B) size based on at least one of the PBR or the BSD;
based on the bucket size being greater than 0, allocating first-stage uplink resources to at least one packet among the plurality of packets of the logical channel, the at least one packet corresponding to a range of the bucket size;
decreasing the bucket size based on a size of the allocated first-stage uplink resources; and
allocating second-stage uplink resources to each of remaining packets of the logical channel.
